(19) United States
(12) Patent Application Publication
(10) Pub. No.: US 2011/0311335 A1
(43) Pub. Date: Dec. 22, 2011

(54) REMOVABLE FASTENER

(76) Inventor: Douglas Wike, Dallas, TX (US)

(21) Appl. No.: 12/819,543

(22) Filed: Jun. 21, 2010

(51) Int. Cl. F16B 21/02

(52) U.S. Cl. 411/508

(57) ABSTRACT

A connector for removably fastening an ornamental object to an article comprising a fastener receptacle having a cavity defined by an inner surface and a top connective lip forming a keyhole opening for receiving a fastener member having at least one radially extending foot configured to pass through the keyhole opening and to rotate within said cavity. The inner surface further has a nodule and a stop creating at least one generally J-shaped catch. The connector further has at least one flexing tab for exerting a force on the fastener member for positioning the at least one radially extending foot between the nodule and the stop thereby removably locking the fastener member in place. Also provided is a means for affixing the receptacle to the article and a means for securing the ornamental object to the fastener member outside the cavity.

### FIELD OF THE INVENTION

The present disclosure relates generally to a quarter turn fastener and more particularly to a quarter turn fastener for removably securing an ornamental item onto an article of clothing, and even more particularly for a quarter turn fastener for removably securing an ornamental item onto a children's shoe.

### BACKGROUND OF THE INVENTION

There are a number of quarter turn fasteners known in the art wherein the vast majority of these fasteners are designed to fasten two (or more) sheets of poster-board or the like together. These fasteners typically have a head and shank with the shaft having a pair of radially outwardly extending flanges. The shank passes through a slot in a panel and is rotated, usually by the means of the head piece, causing the flanges to no longer properly line up with slot but be supported by the rear face of panel. The fastener is either permanently or releasably mounted on the panel. However, the shaft of the fastener passes through the panel and projects beyond the rear plane of the panel. Examples of these types of fasteners can be found in U.S. Pat. No. 4,262,394 issued to Wright, U.S. Pat. No. 4,657,462 issued to Hoen, U.S. Pat. No. 4,762,437 issued to Mitomi, U.S. Pat. No. 5,011,356 issued to Fernandez, U.S. Pat. No. 6,575,682 issued to Dohm, et al., and U.S. Pat. No. 6,612,795 issued to Kirchen.

When using quarter turn fasteners to modify the appearance of an article of apparel, the projection of the shaft beyond the rear face of the rear panel either disrupts the natural appearance of the article by causing the article to pucker, or else the shaft projects into the body of the wearer causing discomfort. Discomfort is greatest when the panel is made of minimally flexible material—such as leather or canvas as is commonly used in footwear. Footwear is typically designed to be stylish, comfortable, ergonomic, and/or practical. However, each pair of footwear is usually limited to its appearance at the time it is purchased. Providing an article of footwear with removable, interchangeable ornamental elements allows a wearer to modify the shoe's appearance.

Traditionally, snaps have been the most used fastener for attaching decorative devices to footwear. Examples of fasteners can be seen in U.S. Pat. No. 4,712,319 to Goria discloses footwear having interchangeable safety aids; U.S. Pat. No. 5,586,888 to Webb discloses a shoe system for children wherein, when placed side-by-side, the left shoe and right shoe form an image allowing the child to know if the correct shoe is on the correct foot; and U.S. Pat. No. 5,673,501 to Mathews describes a shoe with a removable decorative element held in place with a snap. The holding power of these examples, however, frequently allows the ornamental object to unintentionally become detached as a person walks and the shoe bends. One approach to remedy unintentional dislodgement of ornamental objects is to increase the physical holding power of the snap. However, this approach suffers from a significant drawback; namely, if the snap is too secure a wearer will be unable to remove the accessory, thus defeating the purpose of the removable ornamental object for a shoe in the first place.

A possible alternative to snaps for changeably attaching ornamental objects to articles of apparel is the use of a quarter turn fastener. An example of a quarter turn fastener for use with footwear is the device shown in U.S. Pat. Nos. 6,108,944 and 6,463,681 issued to Savoie. The Savoie patents disclose a quarter turn fastening system for interchangeable cleats on athletic shoes. The sole of the athletic shoe is designed with a number of specially configured receptacles. A series of removable cleats with complementary projections is then removably inserted into the receptacles. Of particular note, the soles and the cleat receptacles of the athletic shoes are composed of a rigid plastic material. The sole is not designed to be flexible but is rigid to protect the wearer's foot while competing. Additionally, the cleat projections and sole receptacles are design to lock the cleat into position and resist torsional/rotational motion such that the cleat does not become dislodged during use. The rigid receptacle/projection and locking mechanism render this type of quarter turn fastener unsuitable for use on the upper portions of a shoe, much less for use on other types of apparel.

Therefore, it is clear that a long felt need exists for a rigid yet flexible quarter turn fastening system for securing removable ornamentation to an article of apparel, namely footwear, that is simple to change without requiring special tools or excessive user strength, while also being resistant to accidental dislodgment.

### SUMMARY OF THE INVENTION

It is a general object of the present disclosure to provide a simple means of attaching decorative ornaments onto an article of apparel using a quarter turn fastener.

It is a further object of the present disclosure to provide a means of displaying decorative ornaments through use of a quarter turn fastener on an article of apparel without creating an uncomfortable projection.

Yet another object of the present disclosure is to provide a means of a quarter turn fastening system that does not take disrupt the appearance of the article of apparel.

Yet another object of the present disclosure is to provide a means of using a quarter turn fastening device for securing items such as a strap, lip, flap or collar on articles of apparel that are distorted during normal day-to-day activities.

These and other objects, features and advantages of the present disclosure are achieved in accordance with the present invention which provides a connector for removably fastening an ornamental object to an article comprising a fastener receptacle having a cavity defined by an inner surface and a top connective lip forming a keyhole opening for receiving a fastener member having at least one radially extending foot configured to pass through the keyhole opening and to rotate within said cavity. The inner surface further has a nodule and a stop creating at least one generally J-shaped catch. The connector further has at least one flexing tab for exerting a force on the fastener member for positioning the at least one radially extending foot between the nodule and the stop thereby removably locking the fastener member in place. Also provided is a means for affixing the receptacle to the article and a means for securing the ornamental object to the fastener member outside the cavity.

Preferably the accessory connector is adapted to be used with a variety of different ornamental objects. Various attachment means may be employed to secure the ornamental objects to the shoe. The connector may be fabricated from various materials including, for example, metals, such as steel, aluminum, or the like, or non-metallic materials, such as plastic. Preferably, the material is lightweight, i.e. low density plastic. The ornamental object may be attached by various means using, for example, thread, screws, rivets, snaps, and the like. These and other objects, features and advantages of the present disclosure will become readily apparent to those having ordinary skill in the art upon a reading of the following detailed description in view of the appended claims and drawings.

### BRIEF DESCRIPTION OF THE DRAWING

FIG. 1 is a top perspective view of a receptacle unit of a quarter turn fastener according to the principles of the present disclosure.

FIG. 2 is a bottom perspective view of a receptacle unit of a quarter turn fastener according to the principles of the present disclosure.

FIG. 3 is a top view of a receptacle unit of a quarter turn fastener according to the principles of the present disclosure.

FIG. 4 is a cross-sectional side view of the receptacle unit of a quarter turn fastener according to the principles of the present disclosure taken generally along line 4-4 of FIG. 3.

FIG. 5 is a top perspective view of a fastening member of a quarter turn fastener according to the principles of the present disclosure.

FIG. 6 is a bottom perspective view of a fastening member of a quarter turn fastener according to the principles of the present disclosure.

FIG. 7 is a top perspective view of a plug unit of a quarter turn fastener according to the principles of the present disclosure.

FIG. 8 is a top perspective view of a quarter turn fastener according to the principles of the present disclosure.

FIG. 9 is a bottom perspective view of a quarter turn fastener according to the principles of the present disclosure.

FIG. 10 is a top view of a quarter turn fastener according to the principles of the present disclosure.

FIG. 11 is a cross-sectional side view of a quarter turn fastener according to the principles of the present disclosure taken generally along line 11-11 of FIG. 10.

FIG. 12 is a perspective view of a shoe constructed according to the principles of the present disclosure.

FIG. 13 is a cross-sectional side view of the toe region of a shoe constructed according to the principles of the present disclosure taken generally along line 14-14 of FIG. 12 with an ornamental object above the fastener receptacle.

FIG. 14 is a cross-sectional side view of the toe region of a shoe constructed according to the principles of the present disclosure taken generally along line 14-14 of FIG. 12 with an ornamental object fastened to the shoe.

### DETAILED DESCRIPTION OF THE PREFERRED EMBODIMENT

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this disclosure as required by 35 U.S.C. §112.

For a variety of reasons, fashion wear, and more particularly footwear, is typically designed to be stylish, comfortable, ergonomic, and/or practical. However, each article of apparel is usually limited to its appearance at the time it is purchased. The present disclosure describes a quarter turn fastener designed to be comfortably integrated into an article of apparel for the easy removal and replacement of ornamental objects on the article. More particularly, while the quarter turn fastener of the present disclosure can be used in numerous classes of apparel, such as belts, handbags, and clothing, the present quarter turn fastener is designed for an article of footwear.

The quarter turn fastener includes a fastener receptacle unit comprised of a wall having a cavity defining a keyhole opening. The keyhole opening is a pair of notches indented into the wall opposite one another. The receptacle further has a pair of flexing tabs, each attached at one end to the bottom of the receptacle and projecting upwardly into the cavity at an angle. A fastener member having thin radially extending feet at one end which cooperate with the notches in the receptacle is removably insertable into the receptacle. The fastening member is insertable into the cavity by engaging the extending feet with the notches and compressing the flexing tabs through downward applied pressure.

The fastening member is then rotated within the receptacle such that the extending feet no longer correspond with the notches within the receptacle. The inner wall of the receptacle is configured with shoulders which allow the extending feet to rotate in only one direction when the fastener member is inserted into the receptacle. When removing the fastener member, the shoulder aligns the extending feet with the keyhole opening for easy release. When the fastener member is rotated for fastening, the shoulders permit rotation in only one direction and align the fastener in a position to be locked. The inner wall of the receptacle is further configured with corresponding generally J-shaped catches formed between a stop and a nodule. The extending feet, with downward pressure applied to the flexing tabs, are able to pass under the nodules (the shorter vertical arm of the J-shape) but not under the stops (the longer vertical arm of the J-shape) on the inner wall. The stop is positioned to ensure the fastener member can only rotate approximately one quarter of a turn. Once the fastener member is rotated a quarter turn to secure the member, the user-applied downward pressure is released. Releasing the applied pressure allows the flexing tabs to partially relax their compression and direct the extending feet into the generally J-shaped catch thereby securing the fastener member in the receptacle. The extending feet are no longer able to slide under the nodules and the fastening member is rotationally/torsionally secure. The extending feet prevent the fastener member from being inadvertently released from the receptacle during use while the generally J-shaped catch keeps the fastener member from shifting and possibly dislodging itself. In a preferred embodiment, the components of the quarter turn fastener are constructed of a lightweight yet rigid material, such as plastic.

Preferably, the article of apparel, namely footwear such as a children's shoe, is configured to permanently house the receptacle of the quarter turn fastener. In one embodiment, the receptacle has a thin base plate extending outwardly from the bottom portion of the wall of the receptacle. In a preferred embodiment, the thin plate is made of the same material as the receptacle, and the plate and receptacle are a single contiguous unit. Further, the plate is preferably designed to be rigid yet flexible allowing the plate to flex as the apparel is being worn, while also being thin enough so as not to bulge or otherwise compromise the aesthetics of the article. This plate can be affixed to the external surface of a layer of an article of apparel; or the plate can be affixed to the inner surface of a layer with the receptacle outwardly passing through the layer; or more preferably, the plate can be affixed between an inner and outer layer with the receptacle passing outwardly through the outer layer. For example, in the case of footwear, the thin base plate of the receptacle is confined between the inner layer and outer layer of the upper of the shoe such that the overall surface appearance of the shoe is minimally distorted by the plate. The receptacle can be pressed, stapled, glued, or more preferably, stitched into place.

The fastener member has an ornamental accessory removably attached on a platform opposite the end possessing the extending feet so that, when the receptacle and fastener member are locked together through use of the quarter turn locking mechanism, the fastener removably modifies the appearance of the article of footwear. The platform can be configured for use with a variety of removable fastening means including, but not limited to, stitching, a snap, hook and loop, or a button. The quarter turn fastener quickly and easily allows ornamental accessories to be interchanged while preventing the accessories from being easily dislodged during ordinary wear. Therefore, an article of apparel, namely footwear, possessing a quarter turn fastener having interchangeable ornamental elements allows a wearer to quickly, easily, and repeatedly modify the article of footwear's appearance.

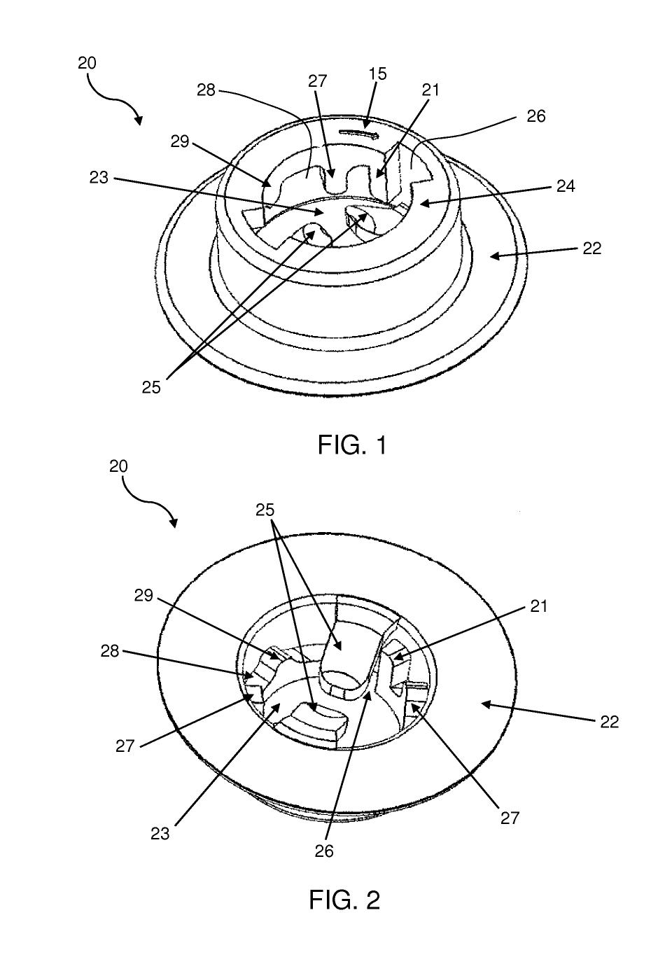

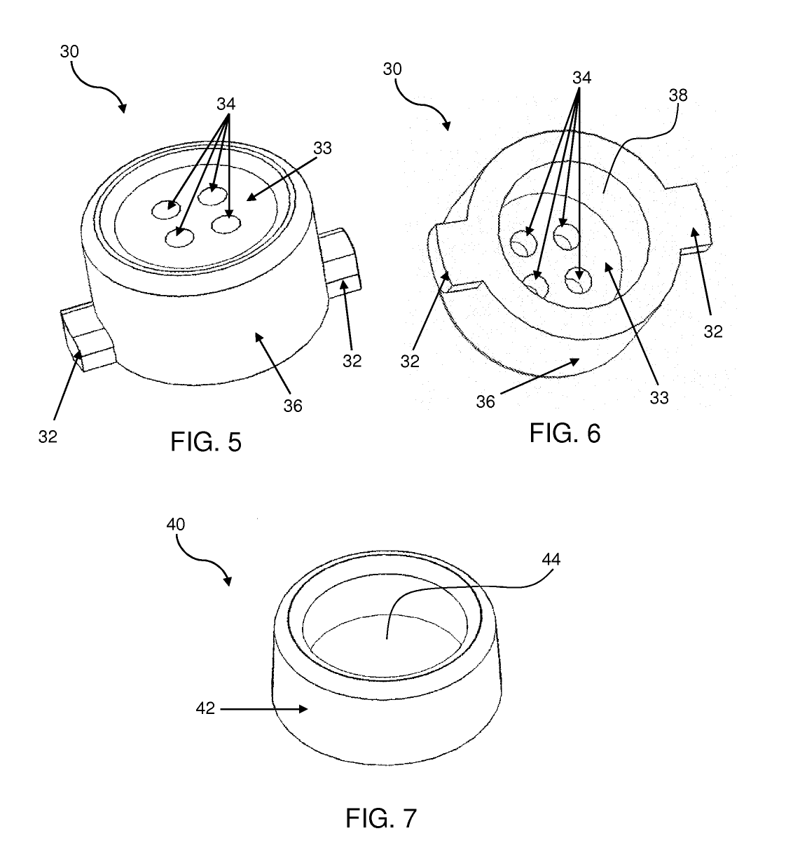

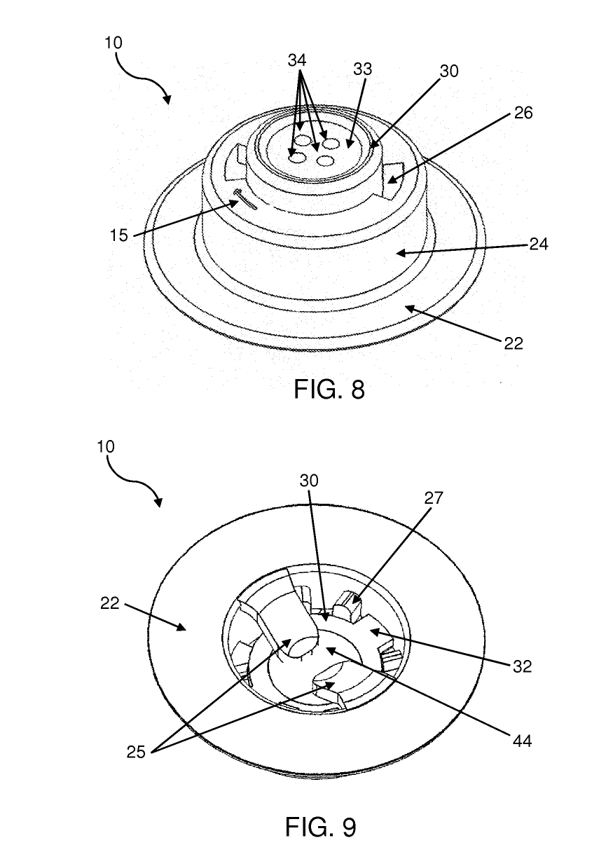

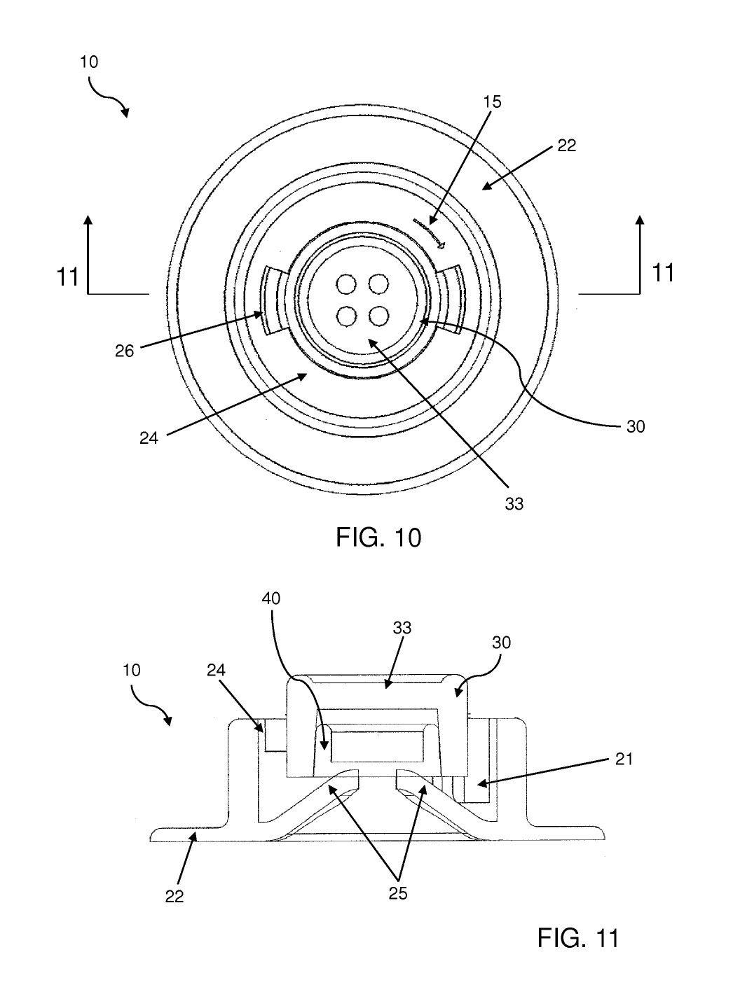

Adverting now to the drawings, FIGS. 1 through 11 are various views of component parts 20 (FIGS. 1 through 4—the fastener receptacle), 30 (FIGS. 5 and 6—the fastener member) and 40 (FIG. 7—the plug) that, when assembled, form completed quarter turn fastener 10 (as shown in FIGS. 8 through 11) of a preferred embodiment of the present invention.

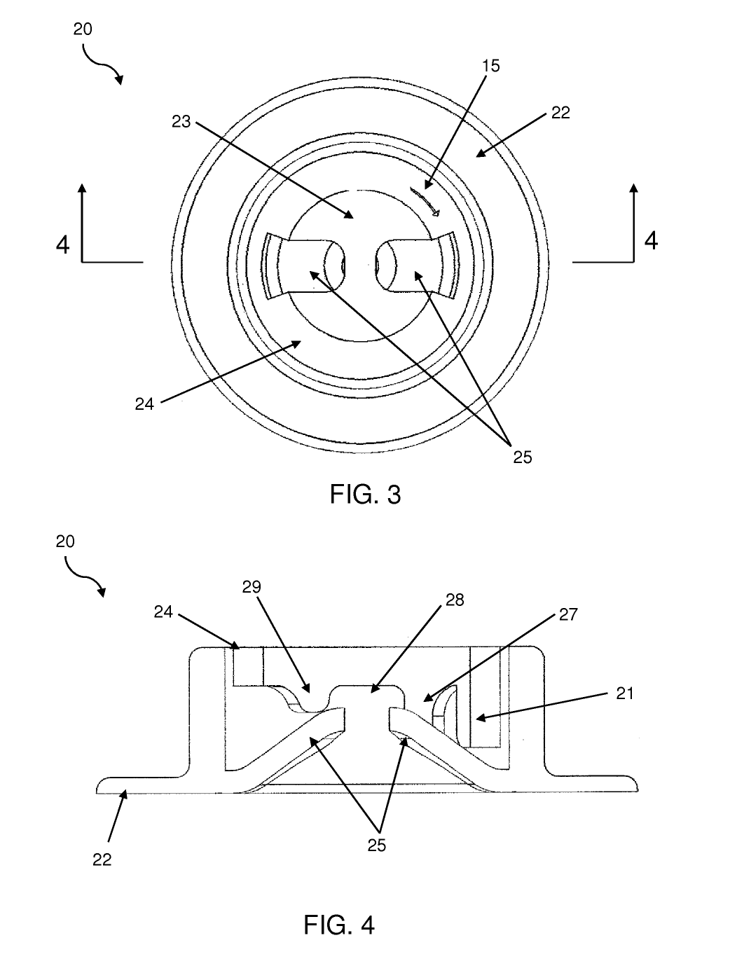

FIGS. 1 and 2 are top and bottom perspective views, respectively, of receptacle 20. FIG. 3 is a top view of a receptacle unit of a quarter turn fastener according to the principles of the present disclosure while FIG. 4 is a cross-sectional side view of the receptacle unit of a quarter turn fastener according to the principles of the present disclosure taken generally along line 4-4 of FIG. 3. Receptacle 20 comprises a cavity 23 defined by an inner surface and a top connective lip 24 forming a keyhole opening. Receptacle 20 further has a thin base plate 22 extending radially outward from the bottom of the receptacle. Flexing tabs 25 are attached at the bottom of the inner surface of the receptacle and extend upwardly at an angle into cavity 23. The keyhole opening in the inner surface is configured with notches 26 which extend outwardly from the cavity and are roughly one half the width of the receptacle.

In a preferred embodiment, the keyhole opening comprises two notches 26 wherein each notch is positioned directly opposite one another in the receptacle. The inner surface of the receptacle is further configured to interact with the fastener member's radially extending feet 32 (as shown in FIGS. 5 and 6). The inner surface has shoulder 21 which forms one half of notch 26. Shoulder 21 extends substantially the entire depth of cavity 23. Shoulder 21 permits the fastener member extending feet to rotate in only one direction when fastening, as shown by arrow 15, and assists in stopping and aligning the fastener member extending foot with notch 26 when removing the fastener member from the receptacle. The inner wall of the receptacle is further configured with a generally J-shaped catch 28 formed between a stop 27 (the longer vertical arm of the J-shape) and a nodule 29 (the shorter vertical arm of the J-shape). When fastening the fastener member, extending foot 32 (see FIGS. 5 and 6) passes under nodule 29 but not under stop 27 and rests within catch 28.

FIGS. 5 and 6 are top and bottom perspective views, respectively, of fastener member 30. Fastener member 30 comprises post 36 having a pair of opposing extending feet 32 extending radially outward from the bottom of the post 36. Extending feet 32 have a width and length configured to correspond and insert into notches 26 of receptacle 20 (see FIGS. 1 through 4). Further, extending feet 32 have a thickness which permits the extension to pass under nodule 29 during rotation of the fastener member, but not to pass under shoulder 21 or stop 27 (see receptacle 20, FIGS. 1 through 4). Post 36 further comprises a post cavity 38 such that post 36 has an inner surface, an outer surface, and a top platform 33. Top platform 33 is configured to accommodate an ornamental object. In a preferred embodiment, top platform 33 has a plurality of through-holes 34 which allow an ornamental object to be affixed to the fastener member by use of a sewn thread connection. Although the top plate has been shown configured for sewn threads, additional embodiments envision other means of affixing an object to the top platform, such as but not limited to removable means including buttons, snaps, hook-and-loop, hook-and-eye, clips, and the like, and non-removable means including glue, epoxy, and the like. In an alternative embodiment, post 36 is constructed without cavity 38 but is a solid body having extending feet 32 extending outwardly from the bottom of the post as described above.

FIG. 7 shows a perspective view of plug 40 of one embodiment of the present disclosure. Plug 40 is designed to fit snuggly within post cavity 38 of fastener member 30 (see FIGS. 3 and 4) so that the plug is removably held in place by friction. Alternatively, plug 40 is permanently inserted into post cavity 38 and affixed with a glue or epoxy. Plug 40 is comprised of plug wall 42 and plug base 44 defining a plug cavity. The plug cavity is configured, in one embodiment of the present disclosure, to accommodate the affixing means of fastener member 30 such that, when inserted into post cavity 38, plug base 44 lies flush with the bottom of post 36 and extensions 32.

FIGS. 8 through 11 show an assembled quarter turn fastener according to one embodiment of the present disclosure. In operation, fastener member 30 is inserted into the cavity of the receptacle with extending feet 32 corresponding with notches 26 of the receptacle. Downward pressure is exerted on flexing tabs 25 by plug base 44 thereby compressing the flexing tabs allowing extending feet 32 to slide below the nodule on the inner wall of the receptacle (see FIGS. 1 through 4). Fastener member 30 is then rotated within the receptacle, as depicted by arrow 15, such that extending feet 32 no longer correspond with notches 26. Shoulders within the inner wall of the receptacle (see FIGS. 1 through 4) restrict rotation of extending feet 32 to only one direction when securing the fastener member. The shoulders further prevent over-rotation of fastener member 30 when removing the fastener member and assist in properly realigning extending feet 32 with notches 26 for removal of the fastener member.

As fastener member is rotated for fastening, extending feet pass under the nodules within the inner wall and the fastener member is further rotated until butting against stop 27. Extending feet 32, with downward pressure applied to the flexing tabs 25, pass under the nodules but not under the stops 27 on the inner wall. Stop 27 is arranged within the receptacle to ensure that fastener member 30 can only turn one quarter of a turn. Once fastener member 30 is rotated a quarter turn to secure the member, the user-applied downward pressure is released. Releasing the downwardly applied pressure allows the flexing tabs 25 to partially relax their compression and direct extending feet 32 into generally J-shaped catches 28 further securing the fastener member in the receptacle. Once directed into generally J-shaped catches 28, extending feet 32 can no longer slide under the nodules and the fastener member is rotationally/torsionally secure.

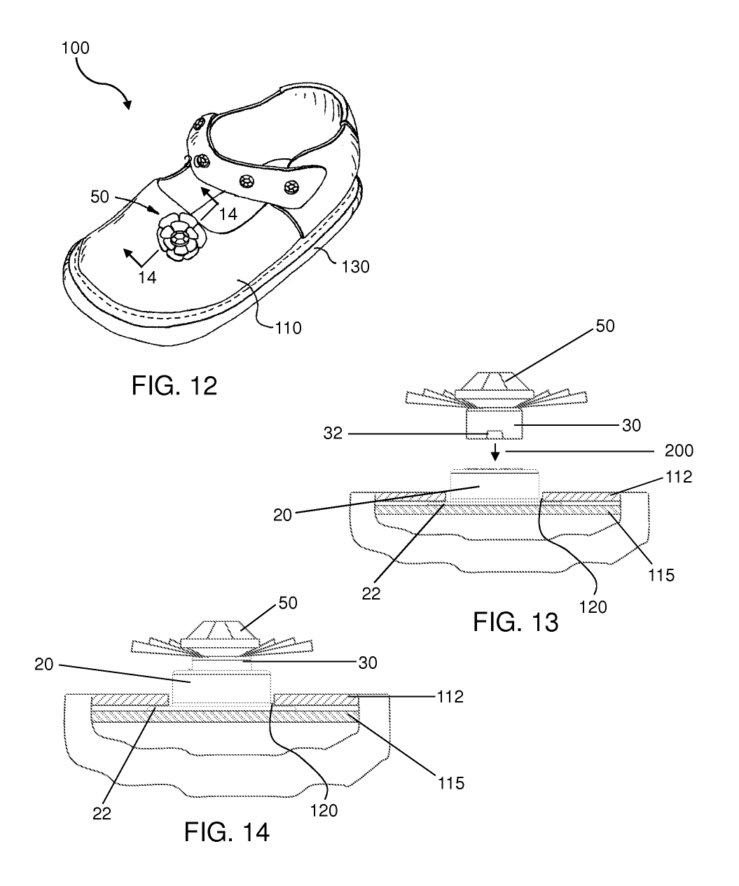

An example of an application using a preferred embodiment of a quarter turn fastener of the present disclosure is provided in FIGS. 12-14 which shows article of footwear 100, a child's shoe which, in a preferred embodiment, further comprises of ornamental item 50 removably attached to the upper part of the shoe, in which an upper 110 is fixably mounted to sole 130. Article of footwear 100 is equipped with a quarter turn fastener for securing an ornamental item 50 onto the article of footwear. In a preferred embodiment, upper 110 is made of leather, although any other material that will provide support for the quarter turn fastener can also be used, such as plastic or rubber. While the ornamental item 50 of this disclosure may be located anywhere throughout the upper part of the shoe, a preferred location is the toe region of upper 110 so as to provide a location which affords maximum visibility to ornamental accessories attached to the footwear. Sole 130 is comprised of a resilient material, such as rubber, which is sturdy enough for contact with the ground while walking.

FIGS. 13 and 14 are cross-sectional side views of the toe region of a shoe constructed according to the principles of the present disclosure taken generally along line 14-14 of FIG. 12 with FIG. 13 showing an ornamental item above the receptacle and FIG. 14 showing the ornamental item attached to the receptacle. As shown in FIGS. 13 and 14, shoe upper 110 is comprised of an inner layer 115 and outer layer 112 wherein outer layer 112 has a hole 120. Base plate 22 is affixed to upper between the inner layer 115 and outer layer 112 proximate hole 120 such that receptacle 20 extends outward from the article of footwear through hole 120. In the instant embodiment, base plate 22 is joined between inner layer 115 and outer layer 112 (which together comprises the upper part of the shoe) by various suitable means of connection such as for example sewed, pressed, stapled or glued and the like. Specifically, base plate 22 is joined between inner layer 115 and outer layer 112 by a stitched connection.

Ornamental item 50 is affixed to fastener member 30 according to the principles of the present disclosure described earlier. Namely, ornamental item 50 is affixed by a sewn thread connection. However, additional affixing means include, but are not limited to, removable means such as buttons, snaps, hook-and-loop, hook-and-eye, clips, and the like, and non-removable means such as glue, epoxy, and the like. When fastening an ornamental item, extending feet 32 are aligned with notches within receptacle 20 (not shown) and directed into receptacle 20 as depicted by arrow 200 as shown in FIG. 13. Fastener member 30 is then rotated a quarter turn as described above to removably fasten ornamental item 50 to receptacle 20 to form a complete shoe as shown in FIG. 14. To add a variety of decoration options, fastener member 30 and receptacle 20 can be constructed of a number of materials including metal, plastic, or the like and can further be coated with a range of metal finishes as well as a range of colors. It will also be appreciated that the disclosure may be employed with any of a variety of types of apparel beyond footwear, including, such as for example, belts, bags, pants, shirts, jackets, and the like.

Although the disclosure has been described with reference to certain preferred embodiments, it will be appreciated by those skilled in the art that modifications and variations may be made without departing from the spirit and scope of the disclosure. It should be understood that applicant does not intend to be limited to the particular details described above and illustrated in the accompanying drawings.

What is claimed is:

1. A connector for removably fastening an ornamental object to an article comprising:
a fastener receptacle having a cavity defined by an inner surface and a top connective lip forming a keyhole opening for receiving a fastener member having at least one radially extending foot configured to pass through said keyhole opening and to rotate within said cavity;
a nodule and a stop creating at least one generally J-shaped catch mounted to said inner surface;
at least one flexing tab connected to said fastener receptacle for exerting a force on said fastener member so that said at least one radially extending foot is pressed between said nodule and said stop to removably lock said fastener member in place;
a means for affixing said receptacle to said article; and
a means for securing said ornamental object to said fastener member outside said cavity.

2. The connector of claim 1 wherein said inner surface further comprises a shoulder which limits rotation direction of said fastener member.

3. The connector of claim 1 wherein said fastener receptacle comprises two flexing tabs integral said inner surface.

4. The connector of claim 3 wherein said article is a shoe.

5. The connector of claim 3 wherein said ornamental object is a bow.

6. The connector of claim 4 wherein said means for affixing said receptacle to said article is a receptacle base plate sewn to an outside of said shoe.

7. The connector of claim 4 wherein said base plate is confined between an inner layer and an outer layer of said shoe positioning said keyhole opening outwardly through a hole in said outer layer of said shoe.

8. The connector of claim 1 wherein said a means for securing said ornamental object to said fastener member outside said cavity is at least one hole for sewing said ornamental object to said fastener member.

9. The connector of claim 1 wherein said a means for securing said ornamental object to said fastener member outside said cavity is a snap stud for removably attaching an ornamental object having a corresponding snap socket.

10. The connector of claim 1 wherein said a means for securing said ornamental object to said fastener member outside said cavity is a button for removably attaching an ornamental object having a corresponding button hole.

11. A connector for removably fastening an ornamental object to an article comprising:
a fastener receptacle having a cavity defined by an inner surface and a top connective lip forming a keyhole opening for receiving a fastener member wherein said fastener member is a hollow post fitted with a plug base having at least one radially extending foot configured to pass through said keyhole opening and to rotate within said cavity;
a nodule and a stop creating at least one generally J-shaped catch mounted to said inner surface;
at least one flexing tab connected to said fastener receptacle for exerting a force on said plug base so that said at least one radially extending foot is pressed between said nodule and said stop thereby removably locking said fastener member in place;
a means for affixing said receptacle to said article; and
a means for securing said ornamental object to said fastener member outside said cavity.

12. The connector of claim 11 wherein said inner surface further comprises a shoulder which limits rotation direction of said fastener member.

13. The connector of claim 11 wherein said fastener receptacle comprises two flexing tabs integral said inner surface.

14. The connector of claim 13 wherein said article is a shoe.

15. The connector of claim 13 wherein said ornamental object is a bow.

16. The connector of claim 14 wherein said means for affixing said receptacle to said article is a receptacle base plate sewn to an outside of said shoe.

17. The connector of claim 14 wherein said base plate is confined between an inner layer and an outer layer of said shoe positioning said keyhole opening outwardly through a hole in said outer layer of said shoe.

18. The connector of claim 11 wherein said a means for securing said ornamental object to said fastener member outside said cavity is a sewing platform having at least one hole for sewing said ornamental object to said fastener member.

19. The connector of claim 11 wherein said a means for securing said ornamental object to said fastener member outside said cavity is a snap platform having a snap stud for removably attaching an ornamental object having a corresponding snap socket.

20. The connector of claim 11 wherein said a means for securing said ornamental object to said fastener member outside said cavity is a button platform having a button for removably attaching an ornamental object having a corresponding button hole.
